(19) United States
(12) Patent Application Publication
(10) Pub. No.: US 2026/0307652 A1
(43) Pub. Date: Oct. 8, 2026

(54) COMPUTER SYSTEM FOR PROVIDING CONTROL DATA FOR A VEHICLE BASED ON A GROUND SURFACE TYPE

(71) Applicant: Volvo Truck Corporation, Göteborg (SE)

(72) Inventors: Mats Jonasson, Partille (SE); Bengt Jacobson, Mölnlycke (SE); Ghazaleh Panahandeh, Göteborg (SE)

(21) Appl. No.: 19/629,155

(22) Filed: Mar. 26, 2026

(30) Foreign Application Priority Data
Apr. 3, 2025 (SE) 2550324-4

(51) Int. Cl. B60W 30/18; B60W 10/04; B60W 40/064; B60W 50/14

(52) U.S. Cl. CPC B60W 30/18172; B60W 10/04; B60W 40/064; B60W 50/14; B60W 2520/10; B60W 2520/26; B60W 2520/28; B60W 2520/30; B60W 2530/16; B60W 2530/201; B60W 2552/15; B60W 2556/40

(57) ABSTRACT

A computer system comprising processing circuitry configured to obtain speed data, obtain wheel force data, obtain reference ground surface data comprising a set of reference ground surface types, determine a slip power loss and a rolling resistance power loss based on the speed data and the wheel force data, determine a ground surface type for a surface based on the slip power loss and rolling resistance power loss and the set of reference ground surface types and provide control data for the vehicle.

### PRIORITY APPLICATIONS

The present application claims priority to Swedish Patent Application No. 2550324-4, filed on Apr. 3, 2025, and entitled “COMPUTER SYSTEM FOR PROVIDING CONTROL DATA FOR A VEHICLE BASED ON A GROUND SURFACE TYPE,” which is incorporated herein by reference in its entirety.

### TECHNICAL FIELD

The disclosure relates generally to vehicles and control of vehicles. In particular aspects, the disclosure relates to a computer system for providing control data for a vehicle based on a ground surface type. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Control over vehicle operation across different terrains can be of importance. This may particularly be the case for heavy-duty vehicles. Existing solutions attempt to manage vehicle parameters by considering road resistance, wheel slip, and tire forces etc., However, they often fall short in accurately classifying ground surface types and adapting to rapid changes in terrain, such as switching from asphalt to gravel or navigating through wet surfaces. This limitation can result in suboptimal vehicle performance, impacting safety and efficiency.

Current methods may lack precision for handling the complex forces on vehicle wheels, leading to increased energy consumption and reduced traction control. This may be particularly problematic in diverse and unpredictable environments, where simplistic models may not desirably capture the nuances of vehicle-ground interactions, compromising vehicle stability and autonomous operation.

In summary, enhanced methods may be desirable to better detect surface types and adapt vehicle control, to allow for a safer and more efficient vehicle operation.

### SUMMARY

According to a first aspect of the disclosure, a computer system is provided. The computer system comprises processing circuitry configured to obtain speed data associated with a ground speed and a rotation speed of a wheel of the vehicle, obtain wheel force data associated with a wheel torque and a longitudinal tire force applied to the wheel, obtain reference ground surface data comprising a set of reference ground surface types, determine a slip power loss and a rolling resistance power loss for a tire of the wheel based on the speed data and the wheel force data, determine a ground surface type for a surface in contact with the tire based on the slip power loss and rolling resistance power loss and the set of reference ground surface types, and provide control data for the vehicle based on the ground surface type. The first aspect of the disclosure may seek to improve the accuracy of the control of the vehicle. A technical benefit may include enhanced vehicle performance and safety through a more accurate adaptation of the operation of the vehicle based on the ground conditions for the tire.

Optionally in some examples, including in at least one preferred example, the processing circuitry is further configured to determine ground surface type based on both the slip power loss and the rolling resistance power loss independent from each other. A technical benefit may include increased accuracy in the determining of the ground surface type. Another technical benefit may include a more simple and non-complex manner of determining the ground surface type.

Optionally in some examples, including in at least one preferred example, each reference ground surface type is associated with surface type indicator data associated with a reference slip power loss and a reference rolling resistance power loss and the processing circuitry is configured to determine the ground surface type based on said surface type indicator data. A technical benefit may include improved reliability in the ground surface classification, Another technical benefit may include a more simple and non-complex manner of determining the ground surface type.

Optionally in some examples, including in at least one preferred example, the processing circuitry is configured to obtain surface inclination data associated with the inclination of the surface, and determine a normal force exerted on the tire based on the wheel force data and the surface inclination data. A technical benefit may include more accurate determination of the ground surface type, as it into account the surface inclination.

Optionally in some examples, including in at least one preferred example, the processing circuitry is further configured to estimate a rolling resistance power loss constant based on the rolling resistance power loss, the speed data and the normal force, and determine the ground surface type based on the rolling resistance power loss constant. A technical benefit may include a more simple and non-complex manner of determining of the ground surface type as the constant enables a dimensionless determining of the rolling resistance.

Optionally in some examples, including in at least one preferred example, the processing circuitry is configured to determine a change in ground surface type of the surface, and responsive to the change in ground surface type provide control data for the vehicle. A technical benefit may include quicker adaptation of the control of the vehicle in situations where the ground surface shifts potentially improving the safety and/or efficiency of the vehicle.

Optionally in some examples, including in at least one preferred example, the processing circuitry is configured to determine a data point based on the slip power loss and the rolling resistance power loss, and determine the ground surface type by mapping of the data point to the set of reference ground surface types. A technical benefit may include a more accurate and non-complex manner of identifying specific ground surfaces.

Optionally in some examples, including in at least one preferred example, the processing circuitry is further configured to obtain speed data associated with a ground speed and a rotation speed of each of a first and second wheel of the vehicle, obtain wheel force data associated with at least a wheel torque and a longitudinal tire force applied to each of the first and second wheel, determine a slip power loss and a rolling resistance power loss for a tire of each of the first and second wheel, determine a ground surface type for a surface in contact with the tire of each of the first and second wheel, and provide control data for the vehicle based on the ground surface type for each of the first and second wheel. A technical benefit may include improved vehicle control by accounting for multiple wheel interactions with various surfaces.

Optionally in some examples, including in at least one preferred example, the processing circuitry is configured to determine the slip power loss based on the rotation speed of the wheel, a radius of the wheel, the ground speed of the wheel and the longitudinal tire force. A technical benefit may include a more precise determining of the slip power loss, potentially improving the control of the vehicle.

Optionally in some examples, including in at least one preferred example, the processing circuitry is configured to determine the rolling resistance power loss based on the rotation speed of the wheel and the wheel torque applied to the wheel. A technical benefit may include more accurate determining of the rolling resistance power loss and consequently the ground surface type.

Optionally in some examples, including in at least one preferred example, the processing circuitry is further configured to obtain speed data associated with a ground speed and a rotation speed of each of a plurality of wheels of the vehicle, obtain wheel force data associated with at least a wheel torque and a longitudinal tire force applied to each of the plurality of wheels, determine a slip power loss and a rolling resistance power loss for a tire of each of the plurality of wheels, determine a ground surface type for a surface in contact with the tire of each of the plurality of wheels, and provide control data for the vehicle based on the ground surface type for each of the plurality of wheels, wherein the wheel force data comprises wheel torque data associated with the wheel torque and the processing circuitry is further configured to obtain the wheel torque data from a propulsion control system of the vehicle, and wherein the wheel force data comprises longitudinal tire force data associated with the longitudinal tire force and the processing circuitry is further configured to obtain the longitudinal tire force data from an accelerometer arranged at the tire, and wherein the processing circuitry is further configured to: determine the slip power loss based on the rotation speed of the wheel, a radius of the wheel, the ground speed of the wheel and the longitudinal tire force. A technical benefit may include enabling control of the vehicle based on the ground surface type for each tire and wheel, allowing for a more safe and efficient operation of the vehicle.

According to a second aspect of the disclosure a vehicle is provided. The vehicle may comprise the computer system of any of the examples described herein. The second aspect of the disclosure may seek to improve the accuracy of the control of the vehicle. A technical benefit may include enhanced vehicle performance and safety through a more accurate adaptation of the operation of the vehicle based on the ground conditions for the tire.

According to a third aspect of the disclosure a computer-implemented method is provided. The computer-implemented method comprises obtaining, by processing circuitry of a computer system, speed data associated with at least one of a ground speed and a rotation speed of a wheel of the vehicle, obtaining, by the processing circuitry, wheel force data associated with a wheel torque and a longitudinal tire force applied to the wheel, obtaining, by the processing circuitry, reference ground surface data comprising a set of reference ground surface types, determining, by the processing circuitry, a slip power loss and a rolling resistance power loss for a tire of the wheel based on the speed data and the wheel force data, determining, by the processing circuitry, a ground surface type for a surface in contact with the tire based on the slip power loss and rolling resistance power loss and the set of reference ground surface types, providing, by the processing circuitry, control data for the vehicle based on the ground surface type. The third aspect of the disclosure may seek to improve the accuracy of the control of the vehicle. A technical benefit may include enhanced vehicle performance and safety through a more accurate adaptation of the operation of the vehicle based on the ground conditions for the tire.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is a schematic side view of a vehicle according to an example.

FIG. 2 is a schematic representation of the parameters for providing control data for a vehicle according to an example.

FIG. 3 is a schematic representation of additional parameters for providing control data for a vehicle according to an example.

FIG. 4 is a schematic side view of a vehicle according to an example.

FIG. 5 is an exemplary system diagram of a vehicle and a computer system according to an example.

FIG. 6 is a schematic representation of aspects of the computer system according to an example.

FIG. 7 is an exemplary system diagram of a vehicle and a computer system according to an example.

FIG. 8 depicts a flow-chart of a computer-implemented method according to an example.

FIG. 9 depicts a flow-chart of a computer-implemented method according to an example.

FIG. 10 depicts a flow-chart of a computer-implemented method according to an example.

FIG. 11 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

In the following various examples will be given all related to the general idea of utilizing a slip power loss and a rolling resistance power loss for a tire to determine a surface type and allow for control of a vehicle based on the surface type.

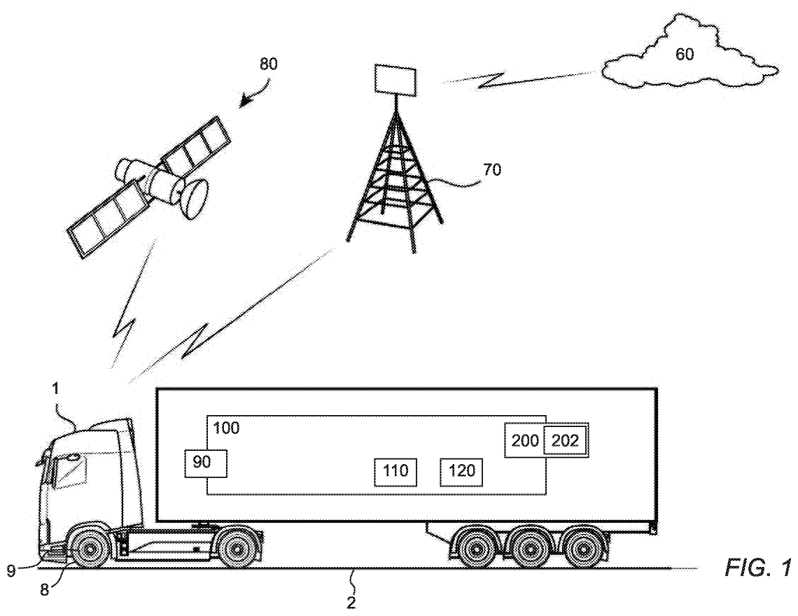

FIG. 1 is an exemplary view of a vehicle 1 according to one example. The vehicle 1 comprises at least one surface determination system 200. The at least one surface determination system 200 is configured to determine a ground surface type for a surface 2 in contact with at least one tire 9 of the vehicle 1.

The vehicle 1 may be programmed to control the surface determination system 200, as will be described further below.

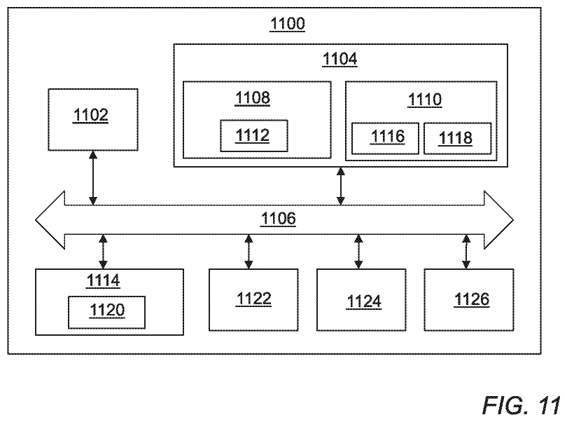

The vehicle 1 comprises, at least to some extent, processing circuitry 110 forming part of a computer system 100 (see FIG. 11). The processing circuitry 110 is configured to implement the surface determination system 200.

The vehicle 1 may further comprise communications circuitry 90 configured to receive and/or send communications. The communications circuitry 90 may be configured to enable the vehicle 1 to communicate with one or more external devices or systems such as a cloud server 60. The communication with the external devices or systems may be directly or via a communications interface such as a cellular communications interface 70, such as a radio base station. The cloud server 60 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The communication circuitry 90 may, additionally or alternatively, be configured to enable the vehicle 1 to be operatively connected to a Global Navigation Satellite System (GNSS) 80 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 1 may for example be configured to utilize data obtain from the GNSS 80 to determine a geographical location of the vehicle 1.

The vehicle 1 in FIG. 1 comprises the computer system 100 and the surface determination system 200. The computer system 100 may be operatively connected to the surface determination system 200 and optionally to the communications circuitry 90 of the vehicle 1. The computer system 100 comprises processing circuitry 110. The computer system 100 may comprise a storage device 120, advantageously a non-volatile storage device such as a hard disk drives (HDDs), solid-state drives (SSDs) etc. In some examples, the storage device 120 is operatively connected to the computer system 100. The surface determination system 200 may comprise surface determination system processing circuitry 202; the surface determination system processing circuitry 202 may be part of the processing circuitry 110 of the computer system 100.

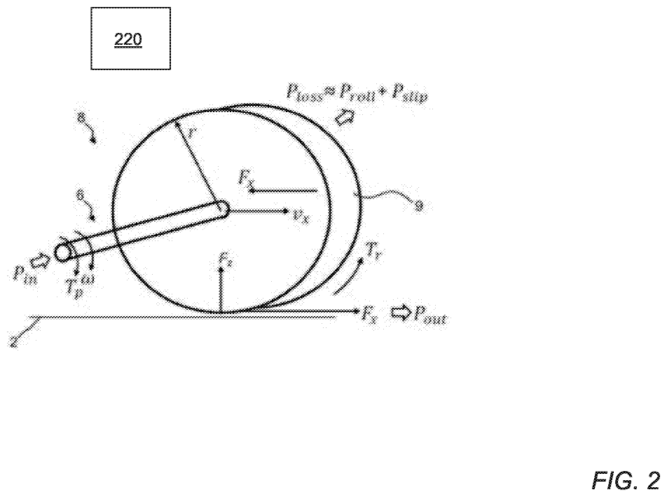

A schematic model of a wheel 8 of the vehicle 1 with a tire 9 is depicted in FIG. 2.

For exemplary purposes, the wheel 8 may exhibit a pure longitudinal motion with two degrees-of-freedom, which means it is rotating with a rotation speed ω and the wheel center of the wheel 8 has a ground speed, i.e. a translational velocity, vₓ. The actuators, e.g. a motor or engine of the vehicle 1, connected to the wheel 8 may generate a wheel torque Tₚ. As a result of the wheel torque Tₚ there may be a rolling resistance Tᵣ. The rolling resistance Tᵣ may act in the opposite direction of the wheel rotation. The rolling resistance Tᵣ may be considered a torque. The rolling resistance Tᵣ causes a longitudinal tire force Fₓ to be applied to the wheel. As depicted, the wheel 8 may have a radius r.

The operation of the wheel 8 may be monitored by the surface determination system 200, which in the shown example is at least partly embodied by a surface determination device 220.

The processing circuitry 110, in FIG. 2 embodied by the surface determination system 200 and in particular the surface determination device 220, is configured to obtain speed data and wheel force data.

The speed data is associated with the ground speed vₓ and the rotation speed ω of the wheel 8 of the vehicle 1. Ground speed may refer to the translational velocity at which the vehicle, e.g. the wheel 8, is traveling over the ground. It is typically measured in m/s. Rotation speed may refer to the angular velocity of the wheel 8. The rotation speed thus indicates how fast the wheel is spinning around its axis. It is typically measured in rotations per minute (RPM) or radians per second.

The wheel force data is associated with the wheel torque Tₚ and the longitudinal tire force Fₓ applied to the wheel 8. As aforementioned, the wheel torque Tₚ may refer to the rotational force applied to the wheel, typically generated by the vehicle's engine or motor. In the depicted example, the wheel torque Tₚ may be applied to the wheel 8 via a wheel axle 6 connected to the wheel 8. This torque causes the turning of the wheel 8 and propels the vehicle 1 forward. The longitudinal tire force Fₓ may be considered the force exerted on the wheel 8, e.g. the tire 9 of the wheel 8, in the direction of travel of the vehicle 1. This force results from the interaction between the tire and the ground surface and may cause propelling of the vehicle 1 forward or may slow it down during braking.

The processing circuitry 110 is further configured to obtain reference ground surface data. The reference ground surface data comprises a set of reference ground surface types.

The processing circuitry 110 is configured to determine a slip power loss Pₛₗᵢₚ for the tire 9 of the wheel 8 based on the speed data and the wheel force data. Correspondingly, the processing circuitry 110 is configured to determine a rolling resistance power loss Pᵣₒₗₗ for the tire 9 based on the speed data and the wheel force data.

The processing circuitry 110 is configured to determine a ground surface type for the surface 2 in contact with the tire 9 based on the slip power loss Pₛₗᵢₚ and the rolling resistance power loss Pᵣₒₗₗ and the set of reference ground surface types.

Based on the ground surface type, i.e. the determined ground surface type, the processing circuitry 110 is configured to provide control data for the vehicle 1.

Hence, the determined rolling resistance power loss Pᵣₒₗₗ and slip power loss Pₛₗᵢₚ may serve basis for the categorization of a surface in contact with the tire 9. Notably, different types of surfaces such as gravel, asphalt, ice etc. are associated with certain characteristics in terms of losses stemming from rolling resistance and slip, thus enabling said categorization.

The slip power loss Pₛₗᵢₚ may refer to the energy, e.g. power, lost due to the tire 9 slipping against the surface 2 during the rotation of wheel 8. This type of loss may occur when there is a difference between the rotation speed ω and the ground speed vₓ, often due to insufficient traction. The slip power loss Pₛₗᵢₚ may be a factor in assessing how effectively a tire 9 can transfer the wheel torque Tₚ into forward motion, impacting the acceleration and braking performance of the vehicle 1.

The rolling resistance power loss Pᵣₒₗₗ may refer to the energy lost due to the deformation of the tire 9 and the surface 2 as the tire rolls. This loss is influenced by factors such as tire characteristics such as tire material and inflation pressure and the type of surface e.g. ground surface type. Rolling resistance power loss may affect the efficiency and overall energy consumption of the vehicle 1, as it may represent the constant energy drain required to maintain motion over a surface.

Hence, slip power loss and rolling resistance power loss may together provide for a more accurate determination of the ground surface type. Different surfaces, like gravel, asphalt, or ice, have distinct characteristics that influence these losses. By analyzing these power losses, the processing circuitry 110 can categorize the surface type, allowing adjustments of the operation of the vehicle 1 based on the ground surface type.

The processing circuitry 110 may be configured to determine the ground surface type 321 based on both the slip power loss Pₛₗᵢₚ and the rolling resistance power loss Pᵣₒₗₗ independent from each other. Hence, the processing circuitry 110 may be configured to determine the ground surface type 321 on both the slip power loss Pₛₗᵢₚ and the rolling resistance power loss Pᵣₒₗₗ as input data.

The processing circuitry 110 may be configured to determine the slip power loss Pₛₗᵢₚ based on the rotation speed ω of the wheel 8, the radius r of the wheel 8, the ground speed vₓ of the wheel 8 and the longitudinal tire force Fₓ.

The processing circuitry 110 may be configured to determine the rolling resistance power loss Pᵣₒₗₗ based on the rotation speed w of the wheel 8 and the wheel torque Tₚ applied to the wheel 8.

In the following, an exemplary manner of determining the slip power loss Pₛₗᵢₚ and the rolling resistance power loss Pᵣₒₗₗ is presented.

The mechanical power transferred into the wheel 8 through the wheel shaft 6 may be determined as:

$${P}_{in} = ω * {T}_{p} \qquad ( 1 )$$

The usable output mechanical power from the wheel 8 may be determined as:

$${P}_{out} = {v}_{x} * {F}_{x} \qquad ( 2 )$$

Consequently, the total mechanical power losses generated from the wheel 8 may be determined as:

$${P}_{loss} = {P}_{in} - {P}_{out} = ω * {T}_{p} - {v}_{x} * {F}_{x} \qquad ( 3 )$$

Assuming that all power losses are formed by the rolling resistance power loss Pᵣₒₗₗ and slip power loss Pₛₗᵢₚ and that the wheel 8 does not store any energy, the power loss may described as follows.

$${P}_{loss} = {P}_{slip} + {P}_{roll} \qquad ( 4 )$$

Even if there are other losses present, e.g. wheel bearing losses, they may be categorized into any of the two types of losses without a large impact on the reliability of the calculations.

The slip power loss Pₛₗᵢₚ may be modelled as follows:

$${P}_{slip} = ( rr * ω - {v}_{x} ) * {F}_{x} \qquad ( 5 )$$

Where rᵣ is the effective rolling resistance.

The rolling resistance power loss Pᵣₒₗₗ may be modelled as follows:

$${P}_{roll} = ω * {T}_{r} \qquad ( 6 )$$

With the above, the total power loss Pₗₒₛₛ may be computed by Equation (3) and the wheel speed data and the wheel force data, i.e. by the ground speed vₓ, the rotation speed ω, the wheel torque Tₚ and the longitudinal tire force Fₓ.

The slip power loss Pₛₗᵢₚ may be determined using Equation (5) above and the same input data, e.g. the wheel speed data and the wheel force data together with an assumed or estimated effective rolling resistance rᵣ.

The rolling resistance power loss Pᵣₒₗₗ may be determined using Equation (4) and may thus be determined as the residual power loss in view of the total power loss Pₗₒₛₛ and the slip power loss Pₛₗᵢₚ. Hence, both the rolling resistance power loss Pᵣₒₗₗ and the slip power loss Pₛₗᵢₚ may be obtained.

As will be explained in further detail later on, the wheel speed data and the wheel force data may be provided in the form of sensor data.

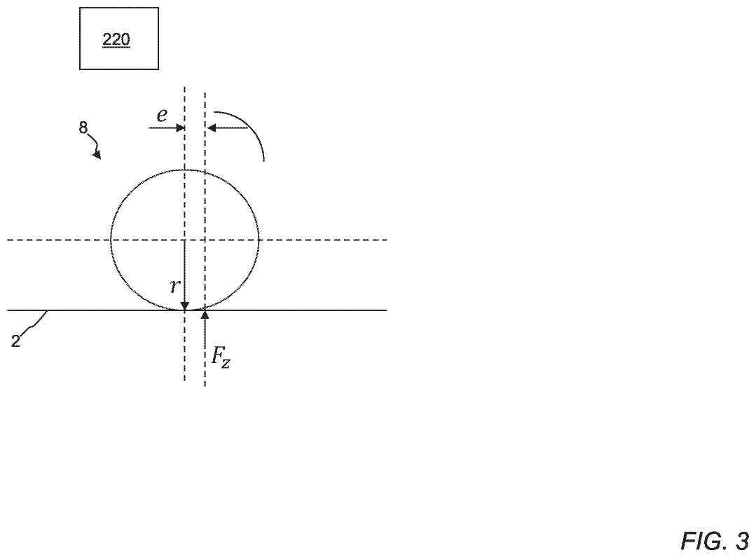

A schematic model of a wheel 8 of the vehicle 1 with a tire 9 is depicted in FIG. 3, providing a more detailed example of the aspects described with reference to FIG. 2.

As depicted, the wheel 8 may have a radius r. The radius r may be considered a tire or loaded radius. Further, the wheel 8 and in particular tire 9 may be subjected to a normal force F_{z}. The normal force F_{z} may be exerted by the surface 2. Further, the normal force F_{z} may be exerted at a normal force offset e. The normal force offset e may be considered the distance between a reference plane extending substantially orthogonally to the surface 2 and the normal force F_{z}, e.g. the longitudinal distance between the center of the normal force and the middle of the tire contact patch of the tire 9.

In one example, the processing circuitry 110 may be configured to obtain surface inclination data. The surface inclination data may be associated with the inclination of the surface 2. The processing circuitry 110 may be configured to determine the normal force F_{z} exerted on the tire 9 based on the wheel force data 310 and the surface inclination data. The rolling resistance Tᵣ may be dependent on the slope angle λ of the surface 2. The effect of the slope may be eliminated from the estimation by division of the rolling resistance Tᵣ by cos(λ).

To enable a more streamlined and efficient control and determination of the ground surface type, at least one of and preferably both of the slip power loss Pₛₗᵢₚ and the rolling resistance power loss Pᵣₒₗₗ may be implemented as dimensionless constants in the determining of the ground surface type.

The processing circuitry 110 may be configured to estimate a rolling resistance power loss constant R_{cc1} based on the rolling resistance power loss Pᵣₒₗₗ, the speed data and the normal force F_{z}. Further, the processing circuitry 110 may be configured to determine the ground surface type based on the rolling resistance power loss constant R_{cc1}.

The rolling resistance power loss constant R_{cc1} may in one example be determined as follows.

$${R}_{cc 1} = \frac{e}{r} \qquad ( 6 )$$

The normal force offset e is related to the rolling resistance Tᵣ and the normal force F_{z} according to the following.

$${T}_{r} = e * {F}_{z} \qquad ( 7 )$$

Wherein the rolling resistance Tᵣ may be determined based on the rotation speed ω and

the rolling resistance power loss Pᵣₒₗₗ:

$${P}_{roll} = ω * {T}_{r} \qquad ( 8 )$$

Thereby, the normal force offset e may be calculated as follows:

$$( 7 ) \to e = \frac{{T}_{r}}{{F}_{z}} \to \{ ins ( 1 ) \} \to {R}_{cc 1} = \frac{{T}_{r} / {F}_{z}}{r} \to \{ ins ( 8 ) \} \to {R}_{cc 1} = \frac{( \frac{{P}_{roll}}{ω} ) / {F}_{z}}{r} = \frac{1}{r * ω * {F}_{z}} * {P}_{roll} \frac{\frac{Nm}{s}}{m * \frac{rad}{s} * N} = 1 \qquad ( 9 )$$

In one example, the processing circuitry 110 may be configured to estimate a slip power loss constant R_{cc2} based on the slip power loss Pₛₗᵢₚ and the longitudinal tire force Fₓ. The processing circuitry may be further configured to determine the ground surface type based on the slip power loss constant R_{cc2}.

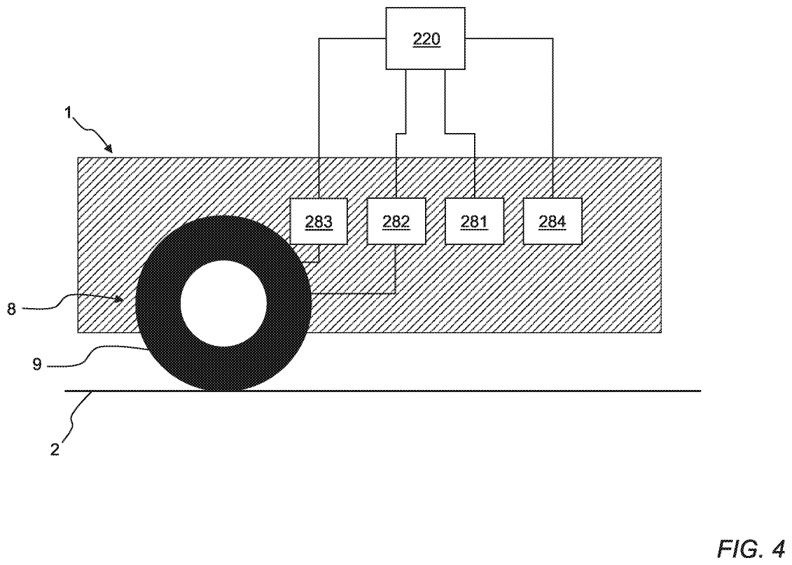

FIG. 4 schematically depicts a side view of a part of the vehicle 1 according to an example.

As depicted, the speed data and the wheel force data may be obtained as sensor data from one or more sensors of the vehicle 1. The processing circuitry 110, herein represented by the surface determination device 220, may be operatively connected to the one or more sensors of the vehicle 1.

In one example, the vehicle 1 may comprise an accelerometer 283. The accelerometer 283 may be arranged at the tire 9. The accelerometer 283 may be configured to collect longitudinal tire force data associated with the longitudinal tire force Fₓ. The accelerometer 283 may be configured to measure said longitudinal tire force Fₓ.

The accelerometer 283 may be provided as a tire force sensor. The tire force sensor may be arranged on the tire 9 for measuring and/or monitoring the forces exerted on the tire 9. Commonly, such tire force sensors are capable of measuring various components of force, including longitudinal forces (which affect acceleration and braking), lateral forces (which influence cornering and stability), and vertical forces (which are related to tire load and contact pressure with the ground). With a conventional tire sensor only tire pressure and temperature is measured. A tire force sensor may however be configured to measure the acceleration characteristics of the tire 9. The tire force sensor may further comprise a tire physics model and may be configured to estimate and provide a force value associated with the longitudinal tire force Fₓ based on said acceleration characteristics and tire force physics model.

In one example, the vehicle 1 may comprise a wheel speed sensor 282. The wheel speed sensor 282 may be configured to monitor and/or measure the rotation speed ω. Advantageously, each wheel may be individually monitored by an associated wheel speed sensor 282 to enable individual determination of the ground surface type for each wheel 8. The wheel speed sensor 282 may be provided as a wheel speed encoder. The wheel speed sensor 282 may function according to the principles of any type of conventional wheel speed sensor. For example, it may be formed by a magnetic inductive sensor, a hall effect sensor, an optical sensor or a resonant sensor.

In one example, the vehicle 1 may comprise a ground speed sensor 281. The ground speed sensor 281 may be configured to monitor and/or measure the ground speed vₓ. The ground speed vₓ may correspond to the travelling speed of the vehicle 1. Hence, the ground speed sensor 281 may be configured to monitor and/or measure the travelling speed of the vehicle 1. Accordingly, one travelling speed sensor may provide the desired data for determining the ground surface type for a plurality of wheels 8. The ground speed sensor 281 may for example be provided as a radar. Other type of suitable sensors may be envisioned however such as lidar or GPS-based sensors.

In one example, the vehicle 10 may comprise an inclination sensor 284 such as a gyroscope. The inclination sensor 284 may be configured to monitor and/or measure the inclination of the surface 2.

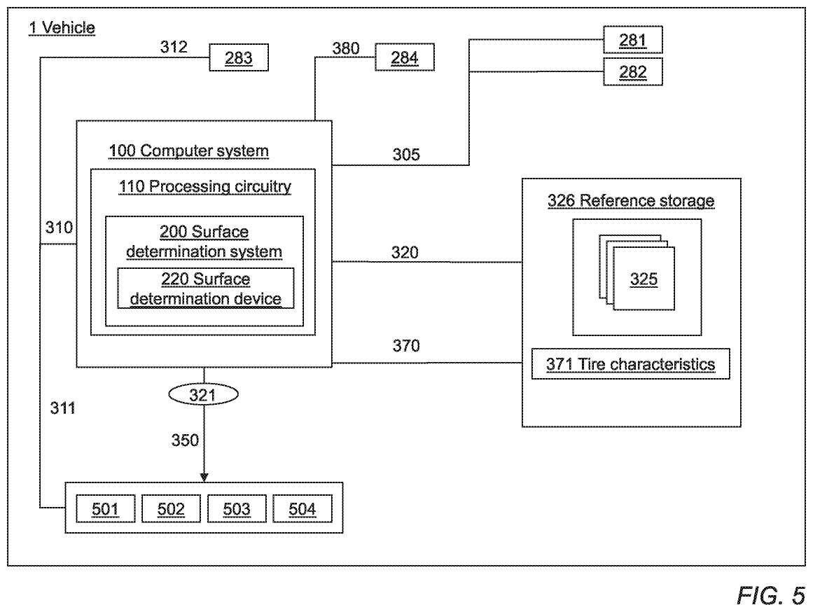

FIG. 5 shows a more detailed example of the vehicle 1.

The processing circuitry 110 is configured to obtain the speed data 305 associated with the ground speed vₓ and the rotation speed ω of the wheel 8 of the vehicle 1. The processing circuitry 110 is configured to obtain wheel force data 310 associated with the wheel torque Tₚ and the longitudinal tire force Fₓ applied to the wheel 8.

The processing circuitry 110 is configured to obtain the reference ground surface data 320. The reference ground surface data 320 comprises a set of reference ground surface types 325.

The processing circuitry 110 is configured to determine a slip power loss Pₛₗᵢₚ and a rolling resistance power loss Pᵣₒₗₗ for the tire 9 of the wheel 8 based on the speed data 305 and the wheel force data 310.

The processing circuitry 110 is configured to determine the ground surface type 321 for the surface 2 in contact with the tire 9 based on the slip power loss Pₛₗᵢₚ and rolling resistance power loss Pᵣₒₗₗ and the set of reference ground surface types 325.

The processing circuitry 110 is configured to provide control data 350 for the vehicle 1 based on the ground surface type 321.

The processing circuitry 110, e.g. the surface determination system 200, may be configured to obtain data from a reference storage 326. The processing circuitry 110, e.g. the surface determination system 200, may be configured to be operatively connected to the reference storage 326. The reference storage 326 may form a part of the computer system 100, another control system of the vehicle 1 or may be at least partially external to the vehicle. The reference storage 326 may comprise a non-volatile memory for storing reference data to be obtained by said processing circuitry 110, e.g. the surface determination system 200.

Further referencing FIG. 5, the processing circuitry 110, e.g. the surface determination system 200, may be configured to obtain the set of ground of reference ground surface types 325 from the reference storage 326. Accordingly, the processing circuitry 110, e.g. the surface determination system 200, may be configured to obtain the reference ground surface data 320 from the reference storage 326.

The processing circuitry 110, e.g. the surface determination system 200, may be configured to obtain tire reference data 370. The tire reference data 370 may be associated with characteristics of the tire 9. The processing circuitry 110, e.g. the surface determination system 200, may be configured to determine the slip power loss Pₛₗᵢₚ and the rolling resistance power loss Pᵣₒₗₗ for the tire 9 based on the tire reference data 370. The tire reference data 370 may comprise any one of a tire thickness, a tire pressure and a tire friction coefficient. The processing circuitry 110, e.g. the surface determination system 200, may be configured to obtain the tire reference data 370 from the reference storage 326. The tire characteristics may serve to increase the accuracy of the surface determination as it allows the slip power loss Pₛₗᵢₚ and the rolling resistance power loss Pᵣₒₗₗ to be determined also based on the particulars of the tire.

The computer system 100 and by extent the processing circuitry 110 and for example the surface determination system 200 may be operatively connected various control systems of the vehicle 1. For example, the processing circuitry 110 may be configured to be operatively connected to any one of a slip control system 501, a traction control system 502, a propulsion control system 503 and a user interface 504 configured to provide an indication to a user.

In one example, the processing circuitry 110, e.g. the surface determination system 200, may be configured to provide the control data 350 for control of at least one of the slip control system 501, the traction control system 502, the propulsion control system 503 and the user interface 504 configured to provide an indication to a user.

The particulars of such systems are well-known to the skilled person and will therefore not be described in great detail.

The slip control system 501 may be configured to control wheel slip of the wheels 9 of the vehicle 1. In particular, the slip control system 501 may be configured to control the slip of the wheel 9 during acceleration, braking, or cornering. The slip control system 501 may serve to control the grip on the road surface to prevent skidding or loss of control. The slip control system 501 may be configured to receive the control data 350 and may be configured to adjust parameters relating to the slip of the wheel 9 based on the ground surface type 321, e.g. to match the current ground surface condition. Thereby, a more precise control the wheel slip may be achieved.

The traction control system 502 may be configured to control spinning of the wheel 9 during acceleration. The traction control system 502 may be configured to control the spinning of the wheel 9 by means of adjusting motor power or applying brakes to individual wheels 9, e.g. the wheel 9. The traction control system 502 may be configured to receive the control data 350 and may be configured to adjust parameters relating to the spinning of the wheel 9 based on the ground surface type 321, e.g. to match the current ground surface condition. This may be achieved by adjusting of the motor power or applying of the brakes. This may allow for an improved power distribution to the wheels 9 with the most grip, improving traction and vehicle control.

The propulsion control system 503 may be configured to control the propulsion of the vehicle 1, for example by means of controlling the output of the motor, transmission and/or power distribution in hybrid or electric vehicles. It aims to optimize performance, efficiency, and drivability. The propulsion control system 503 may be configured to receive the control data 350 and may be configured to adjust propulsion power based on the ground surface type. This may improve fuel efficiency, reduce energy consumption, and/or enable a smoother driving experience across different terrains.

The user interface 504 may be configured to provide an indication to a user. Hence, the user interface 504 may configured to receive the control data 350 and present an indication to a user based on the ground surface type 321. For example, a visual indication may be provided to the driver of the vehicle 1 indicating the surface type which the tire 9 is in contact with. The user interface 504 may for example comprise a display device such as a LED or LCD display. The user interface 504 may be arranged in the cabin of the vehicle 1 or may be provided external to the vehicle 1. The user interface may alert the driver if the ground surface type shifts or if some wheels are in contact with one type of ground surface type and other wheels are in contact with another type of ground surface type etc. This may allow for the driver to adjust the operation of the vehicle 1 to improve safety or energy efficiency.

The control data 350 provided for the control of the vehicle 1 may be of particular importance in situations where vehicle 1 operates according to certain ground conditions and the ground conditions quickly changes. This may be due to the ground surface for the tire 9 changing or when different wheels 8 and their associated tires 9 are in contact with different ground surface types 321. Accordingly, the processing circuitry 110, e.g. the surface determination system 200, may be configured to provide control data 350 for the vehicle 1 in response to changes in ground surface type or different tires 9 being in contact with different ground surface types.

Accordingly, the processing circuitry 110, e.g. the surface determination system 200, may be configured to determine a change in ground surface type 321 of the surface 2. Responsive to the change in ground surface type 321, the processing circuitry 110, e.g. the surface determination system 200, may be configured to provide control data 350 for the vehicle 1.

Hence, the processing circuitry 110, e.g. the surface determination system 200, may be configured to continuously determine the slip power loss Pₛₗᵢₚ and the rolling resistance power loss Pᵣₒₗₗ. A change in the determined slip power loss Pₛₗᵢₚ and the rolling resistance power loss Pᵣₒₗₗ may result in a change of the determined ground surface type 321. In such a case, the control data 350 may prompt either automatic adjustment operation of any of the slip control system 501, the traction control system 502 and the propulsion control system 503 and/or prompt a warning via the user interface 504.

As aforementioned two or more wheels 8, and preferably each of the wheels 8 of the vehicle 1 may be monitored. Hence, processing circuitry 110, e.g. the surface determination system 200, may be configured to determine the ground surface type 321 of at least two tires 9 and preferably each tire 9 of the vehicle.

Thus, the processing circuitry 110, e.g. the surface determination system 200, may be configured to obtain speed data 305 associated with a ground speed vₓ and a rotation speed ω of each of a first and second wheel 8 of the vehicle 1.

The processing circuitry 110, e.g. the surface determination system 200, may be configured to obtain wheel force data 310 associated with at least a wheel torque Tₚ and a longitudinal tire force Fₓ applied to each of the first and second wheel 8.

The processing circuitry 110, e.g. the surface determination system 200, may be further configured to determine a slip power loss Pₛₗᵢₚ and a rolling resistance power loss Pᵣₒₗₗ for a tire 9 of each of the first and second wheel 8.

The processing circuitry 110, e.g. the surface determination system 200, may be further configured to determine a ground surface type 321 for a surface 2 in contact with the tire 9 of each of the first and second wheel 8, and provide control data for the vehicle 1 based on the ground surface type for each of the first and second wheel 8.

The control data 350 may for example be provided for prompting individual control of the first and second wheel 8 by means of the slip control system 501 and/or the traction control system 502 or for prompting an alert for the user via the user interface 504 indicating the ground surface type for each of the first and the second wheel 8.

The first and second wheel 8 may be arranged at opposite longitudinal sides of the vehicle 1 or may be arranged at the same longitudinal side of the vehicle 1.

In one example, the processing circuitry 110, e.g. the surface determination system 200, may be configured to obtain speed data 305 associated with a ground speed vₓ and a rotation speed w of each of a plurality of wheels 8 of the vehicle 1. The processing circuitry 110, e.g. the surface determination system 200, may be configured to obtain wheel force data 310 associated with at least a wheel torque Tₚ and a longitudinal tire force (Fₓ) applied to each of the plurality of wheels 8.

In one example, the processing circuitry 110, e.g. the surface determination system 200, may be configured to determine a slip power loss Pₛₗᵢₚ and a rolling resistance power loss Pᵣₒₗₗ for a tire 9 of each of the plurality of wheels 8.

In one example, the processing circuitry 110, e.g. the surface determination system 200, may be configured to determine a ground surface type 321 for a surface 2 in contact with the tire 9 of each of the plurality of wheels 8.

In one example, the processing circuitry 110, e.g. the surface determination system 200, may be configured to provide control data for the vehicle 1 based on the ground surface type for each of the plurality of wheels 8.

In one example, the wheel force data 310 may comprise wheel torque data 311 associated with the wheel torque Tₚ and the processing circuitry 110 is further configured to obtain the wheel torque data 311 from a propulsion control system 503 of the vehicle 1.

In one example, the wheel force data 310 may comprise longitudinal tire force data 312 associated with the longitudinal tire force Fₓ and the processing circuitry 110 is further configured to obtain the longitudinal tire force data 312 from an accelerometer 283 arranged at the tire 9.

In one example, the processing circuitry 110 may be further configured to determine the slip power loss Pₛₗᵢₚ based on the rotation speed w of the wheel 8, a radius r of the wheel 8, the ground speed vₓ of the wheel 8 and the longitudinal tire force Fₓ.

As previously described with reference to FIG. 4, at least one of the speed data 305 and the wheel force data 310 may be obtained as sensor data.

In one example, the processing circuitry 110, e.g. the surface determination system 200, may be configured to obtain the speed data 305 from one or more speed sensors. The one or more speed sensors may comprise at least one of the ground speed sensor 281 and the wheel speed sensor 282.

In one example, the wheel force data 310 may comprise wheel torque data 311. The wheel torque data 311 may be associated with the wheel torque Tₚ. The processing circuitry 110, e.g. the surface determination system 200, may be configured to obtain the wheel torque data 311 from the propulsion control system 503 of the vehicle 1.

In one example, the wheel force data 310 may comprise longitudinal tire force data 312. The longitudinal tire force data 312 may be associated with the longitudinal tire force Fₓ. The processing circuitry 110, e.g. the surface determination system 200, may be further configured to obtain the longitudinal tire force data 312 from the accelerometer 283 arranged at the tire 9.

Further referencing FIG. 5, the processing circuitry 110, e.g. the surface determination system 200, may be configured to obtain surface inclination data 380. The surface inclination data 380 may be associated with the inclination of the surface 2. The processing circuitry 110, e.g. the surface determination system 200, may be configured to determine normal force F_{z} exerted on the tire 9 based on the wheel force data 310 and the surface inclination data 380. The processing circuitry 110, e.g. the surface determination system 200, may be configured to obtain the surface inclination data 380 from the inclination sensor 284.

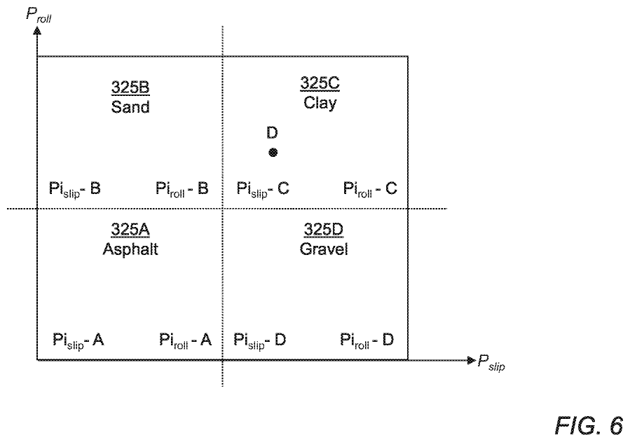

FIG. 6 depicts aspects of the determining of the ground surface type 321. As shown in FIG. 6, the set of reference ground surface types 325 may comprise a plurality of reference ground surface types 325. Notably, the surface determination system 200 may be capable of identifying a variety of ground surface types, each with its unique characteristics affecting traction and control. To identify a plurality of different ground surface types 321, corresponding reference ground surface types 325 may be relied upon.

The reference ground surface types 325 may comprise a reference asphalt ground surface type. Asphalt is a common surface type for roads and highways, known for its smooth and hard texture, providing generally high traction.

The reference ground surface types 325 may comprise a reference gravel ground surface type. Gravel surfaces, composed of loose, small stones or pebbles, present a challenge for traction and are often found on rural roads or driveways, often being associated with relatively high slip.

The reference ground surface types 325 may comprise a reference sand ground surface type. Sand is a loose and granular surface that may be associated with a reduced traction and an increases slip.

The reference ground surface types 325 may comprise a reference clay ground surface type. Clay is a fine-grained natural soil material, can be relatively slippery particularly in wet conditions.

The reference ground surface types 325 may comprise a reference ice ground surface type. Compared to other ground surface types, ice may be associated with significantly lower traction due to its slippery nature.

The reference ground surface types 325 may comprise a reference snow ground surface type. Snow may form a loose surface that can compact under vehicle weight, impacting the rolling and slip resistance.

The reference ground surface types 325 may comprise a reference grass ground surface type. Grass may form a soft surface which may be slippery, especially when wet, affecting vehicle traction.

Each reference ground surface type 325 may be associated with surface type indicator data. The surface type indicator data may be associated with a reference slip power loss Piₛₗᵢₚ and a reference rolling resistance power loss Piᵣₒₗₗ. The processing circuitry 110, e.g. the surface determination system 200, may be configured to determine the ground surface type 321 based on the surface type indicator data.

Hence, each reference ground surface type 325 may be associated with both a reference slip power loss Piₛₗᵢₚ and a reference rolling resistance power loss Piᵣₒₗₗ. The reference slip power loss Piₛₗᵢₚ and the reference rolling resistance power loss Piᵣₒₗₗ may be considered characterizing data for comparing the determined slip power loss Pₛₗᵢₚ and the rolling resistance power loss Pᵣₒₗₗ for the tire 9. Upon the determined slip power loss Pₛₗᵢₚ and the rolling resistance power loss Pᵣₒₗₗ corresponding to the reference slip power loss Piₛₗᵢₚ and a reference rolling resistance power loss Piᵣₒₗₗ associated with one of reference ground surface types 325 of the set of reference ground surface types 325, the ground surface type 321 may be determined to be of said corresponding reference ground surface type 325.

Further referencing FIG. 6, the processing circuitry 110, e.g. the surface determination system 200, may be configured to determine a data point D. The data point D may be determined based on the slip power loss Pₛₗᵢₚ and the rolling resistance power loss Pᵣₒₗₗ. The processing circuitry 110, e.g. the surface determination system 200, may be configured to determine the ground surface type 321 by mapping of the data point D to the set of reference ground surface types 325.

In one example, the determined the slip power loss Pₛₗᵢₚ and the rolling resistance power loss Pᵣₒₗₗ may form the data point D. The data point D may then be mapped against the reference slip power loss Piₛₗᵢₚ and the reference rolling resistance power loss Piᵣₒₗₗ of each of the reference ground surface types 325 to determine the ground surface type 321. As will be described in further detail later this may be achieved either by thresholds or probability.

It may be envisioned that the rolling resistance power loss constant R_{cc1} and the slip power loss constant R_{cc2} forms the data point D. According to such an example, the surface type indicator data may comprise a reference rolling resistance power loss constant and a reference slip power loss constant associated with each reference ground surface type 325. The data point D may thus be mapped against the reference rolling resistance power loss constant and the reference slip power loss constant for each reference ground surface type to determine the ground surface type 321.

Referencing FIG. 6, the reference ground surface types 325 may be mapped with regards to slip power loss and rolling resistance power loss.

In the depicted example, the set of reference ground surface types 325 comprises a reference asphalt ground surface type 325A, a reference sand ground surface type 325B, a reference clay ground surface type 325C and a reference gravel ground surface type 325D.

As evident from FIG. 6, the reference asphalt ground surface type 325A is associated with relatively low slip power losses and rolling resistance power losses, the reference sand ground surface type 325B is associated with relatively low slip power losses and relatively high rolling resistance power losses, the reference clay ground surface type 325C is associated with relatively high slip power losses and rolling resistance power losses and the reference gravel ground surface type 325D is associated with relatively high slip power losses and relatively low rolling resistance power losses.

The data point D is mapped against the surface indicator data associated with each of the reference ground surface types 325. As depicted, the data point D in the depicted example, corresponds to the reference slip power loss Piₛₗᵢₚ-C and the reference rolling resistance power loss Piᵣₒₗₗ-C associated with the reference clay ground surface data 325C. The ground surface type 321 may consequently be determined to be clay. Based on this determination, control data may be provided for the vehicle 1.

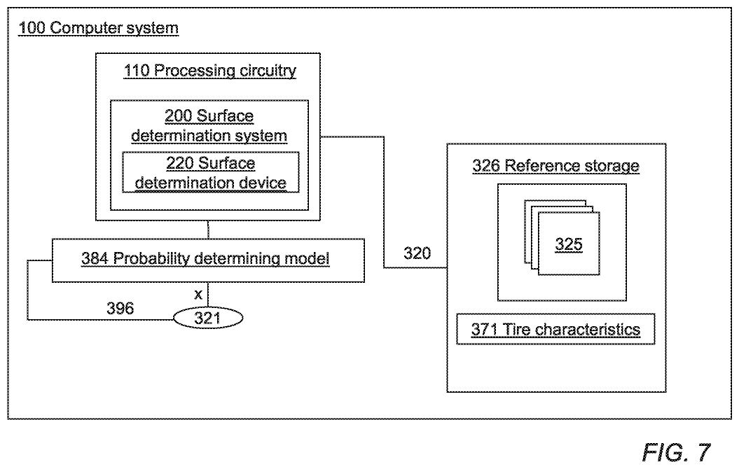

FIG. 7 depicts additional aspects of the determining of the ground surface type 321 according to an example.

The determining of the ground surface type 321 may be based on a probability model or a threshold-based model. In the depicted example, a probability model is utilized.

According to the depicted example, the processing circuitry 110, e.g. the surface determination system 200, may be configured to determine a probability value x for each reference ground surface type 325. The probability value x may be associated with the probability of the ground surface type 321 for the surface 2 is of the reference ground surface type 325. The processing circuitry 110, e.g. the processing circuitry 110, may be configured to determine the ground surface type 321 based on the probability values x.

Accordingly, a plurality of probability values x may be determined, one for each reference ground surface type 325. Based on the probability values x, the processing circuitry 110, e.g. the processing circuitry 110, may be configured to determine the most likely ground surface type 321 by comparison between the probability values x.

In the depicted example, the computer system 100 may comprise a probability determining model 384. The probability determining model 384 may be configured to determine the probability values x. The processing circuitry 110, e.g. the surface determination system 200, may be configured to train the probability determining model 384 based on a classification algorithm. For example, the classification algorithm may be a logistic regression algorithm, a support vector machine or a neural network.

The probability determining model 384 may be trainable. In one example, the processing circuitry 110, e.g. the surface determination system 200, may be configured to operate in a training mode. In the training mode, the processing circuitry 110, e.g. the surface determination system 200, may be configured to obtain surface definition data 396 associated with a set surface type of the surface 2 and assign a ground surface type 321 to the surface 2 based on the surface definition data 396 and train the probability determining model 384 based on the operation of the vehicle 1 on the surface 2.

For example, a user may, in the training mode, via the user interface 504 assign a surface which is currently in contact with the tire 9 with a ground surface type 321. This assigned ground surface type 321 may form basis for the probability determining model 384 for determining the probability value x. It may for example be envisioned that a user may select and assign the ground surface type 321 by selecting among the set of reference ground surface types 325.

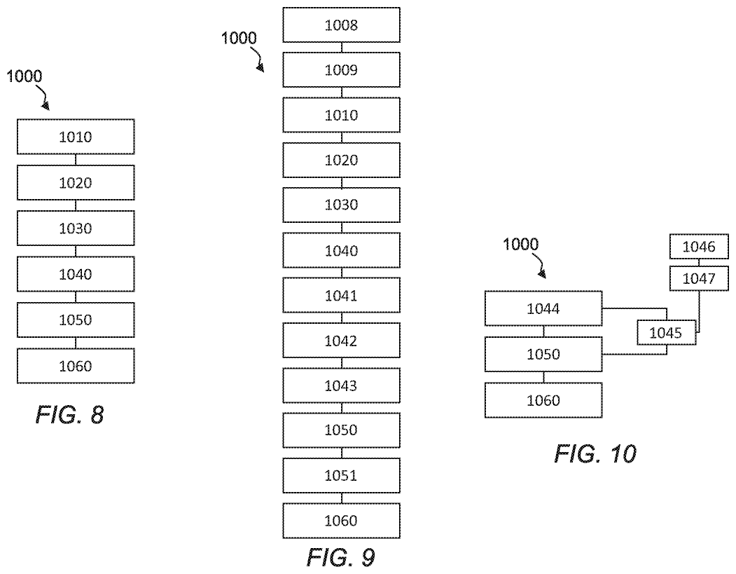

FIG. 8 is a flow chart of a method 1000 according to an example. The method 1000 may be a computer-implemented method.

The method 1000 comprises obtaining 1010, by processing circuitry 110 of a computer system 100, speed data 305 associated with at least one of a ground speed and a rotation speed of a wheel 8 of the vehicle 1, obtaining 1020, by the processing circuitry 110, wheel force data 310 associated with a wheel torque Tₚ and a longitudinal tire force Fₓ applied to the wheel 8. The method further comprising, obtaining 1030, by the processing circuitry 110, reference ground surface data 320 comprising a set of reference ground surface types 325. The method further comprises determining 1040, by the processing circuitry 110, a slip power loss Pₛₗᵢₚ and a rolling resistance power loss Pᵣₒₗₗ for a tire 9 of the wheel 8 based on the speed data 305 and the wheel force data 310. The method further comprises determining 1050, by the processing circuitry 110, a ground surface type 321 for a surface 2 in contact with the tire 9 based on the slip power loss Pₛₗᵢₚ and rolling resistance power loss Pᵣₒₗₗ and the set of reference ground surface types 325. The method further comprises providing 1060, by the processing circuitry, control data 350 for the vehicle 1 based on the ground surface type 321.

FIG. 9 depicts the method according to a more detailed example.

Optionally, the method may comprise determining 1050, by the processing circuitry 110, the ground surface type 321 based on both the slip power loss Pₛₗᵢₚ and the rolling resistance power loss Pᵣₒₗₗ independent from each other.

Optionally, each reference ground surface type 325 may be associated with surface type indicator data associated with a reference slip power loss Piₛₗᵢₚ and a reference rolling resistance power loss Piᵣₒₗₗ. Optionally, the method may further comprise determining 1050, by the processing circuitry 110, the ground surface type 321 based on said surface type indicator data.

Optionally, the method may comprise obtaining 1009, by the processing circuitry 110, surface inclination data 380 associated with the inclination of the surface 2, and determining, by the processing circuitry 110, a normal force F_{z} exerted on the tire 9 based on the wheel force data 310 and the surface inclination data 380.

Optionally, the method may comprise estimating 1041, by the processing circuitry 110, a rolling resistance power loss constant R_{cc1} based on the rolling resistance power loss Pᵣₒₗₗ, the speed data 305, and the normal force F_{z}, and determining 1050, by the processing circuitry 110, the ground surface type 321 based on the rolling resistance power loss constant R_{cc1}.

Optionally, the method may comprise estimating 1042, by the processing circuitry 110, a slip power loss constant R_{cc2} based on the slip power loss Pₛₗᵢₚ and the longitudinal tire force Fₓ, and determining, by the processing circuitry 110, a ground surface type 321 based on the slip power loss constant R_{cc2}.

Optionally, the method may comprise obtaining 1008, by the processing circuitry 110, tire reference data 370 associated with characteristics of the tire 9, and determining 1050, by the processing circuitry 110, the slip power loss Pₛₗᵢₚ and the rolling resistance power loss Pᵣₒₗₗ for the tire 9 based on the tire reference data 370.

Optionally, the method may comprise determining 1051, by the processing circuitry 110, a change in ground surface type 321 of the surface 2, and responsive to the change, providing 1060, by the processing circuitry 110, control data 350 for the vehicle 1.

Optionally, the method may comprise providing 1060, by the processing circuitry 110, control data for control of at least one of: a slip control system 501, a traction control system 502, a propulsion control system 503, and a user interface 504 configured to provide an indication to a user.

Optionally, the method may comprise determining 1043, by the processing circuitry 110, a data point D based on the slip power loss Pₛₗᵢₚ and the rolling resistance power loss Pᵣₒₗₗ, and determining 1050, by the processing circuitry 110, the ground surface type 321 by mapping the data point D to the set of reference ground surface types 325.

Optionally, the method may comprise obtaining 1010, by the processing circuitry 110, speed data 305 associated with a ground speed vₓ and a rotation speed ω of each of a first and second wheel 8 of the vehicle 1, obtaining 1020, by the processing circuitry 110, wheel force data 310 associated with at least a wheel torque Tₚ and a longitudinal tire force Fₓ applied to each of the first and second wheel 8, determining 1040, by the processing circuitry 110, a slip power loss Pₛₗᵢₚ and a rolling resistance power loss Pᵣₒₗₗ for a tire 9 of the first and second wheel 8, determining 1050, by the processing circuitry 110, a ground surface type 321 for a surface 2 in contact with the tire 9 of each of the first and second wheel 8, and providing 1060, by the processing circuitry 110, control data for the vehicle 1 based on the ground surface type for each of the first and second wheel 8.

Optionally, the first and second wheel 8 may be arranged at opposite longitudinal sides of the vehicle 1.

Optionally, the first and second wheel 8 may be arranged at the same longitudinal side of the vehicle 1.

Optionally, the method may comprise determining 1040, by the processing circuitry 110, the slip power loss Pₛₗᵢₚ based on the rotation speed ω of the wheel 8, a radius r of the wheel 8, the ground speed vₓ of the wheel 8, and the longitudinal tire force Fₓ.

Optionally, the method may comprise determining 1040, by the processing circuitry 110, the rolling resistance power loss Pᵣₒₗₗ based on the rotation speed ω of the wheel 8 and the wheel torque Tₚ applied to the wheel 8.

Optionally, the method may comprise obtaining 1010, by the processing circuitry 110, the speed data from one or more speed sensors comprising at least one of a ground speed sensor 281 such as a radar and a wheel speed sensor 282 such as a wheel speed encoder.

Optionally, the wheel force data 310 may comprise wheel torque data 311 associated with the wheel torque Tₚ. Optionally, the method may further comprise obtaining, by the processing circuitry 110, the wheel torque data 311 from a propulsion control system 503 of the vehicle 1.

Optionally, the wheel force data 310 may comprise longitudinal tire force data 312 associated with the longitudinal tire force Fₓ. Optionally, the method may further comprise comprise obtaining, by the processing circuitry 110, the longitudinal tire force data 312 from an accelerometer 283 arranged at the tire 9.

FIG. 10 depicts additional aspects of the method according to one example.

Optionally, the method may comprise determining 1044, by the processing circuitry 110, a probability value x for each reference ground surface type 325, the probability value x being associated with the probability of the ground surface type 321 for the surface 2 being of the reference ground surface type 325, and determining 1050, by the processing circuitry 110, the ground surface type 321 based on the probability values x.

Optionally, the computer system 100 may comprise a probability determining model 384 configured to determine the probability values x. Optionally, the method may further training 1045, by the processing circuitry 110, the probability determining model 384 based on a classification algorithm such as logistic regression, support vector machine, or a neural network.

Optionally, the method may comprise operating, by the processing circuitry 110, in a training mode, and in said training mode: obtaining 1046, by the processing circuitry 110, surface definition data 396 associated with a set surface type of the surface 2, assigning 1047, by the processing circuitry 110, a ground surface type 321 to the surface 2 based on the surface definition data 396, and training 1045, by the processing circuitry 110, the probability determining model 384 based on operation of the vehicle 1 on the surface 2.

FIG. 11 is a schematic diagram of a computer system 1100 for implementing examples disclosed herein. The computer system 1100 is adapted to execute instructions from a computer-readable medium to perform these and/or any of the functions or processing described herein. The computer system 1100 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 1100 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 1100 may comprise at least one computing device or electronic device capable of including firmware, hardware, and/or executing software instructions to implement the functionality described herein. The computer system 1100 may include processing circuitry 1102 (e.g., processing circuitry including one or more processor devices or control units), a memory 1104, and a system bus 1106. The computer system 1100 may include at least one computing device having the processing circuitry 1102. The system bus 1106 provides an interface for system components including, but not limited to, the memory 1104 and the processing circuitry 1102. The processing circuitry 1102 may include any number of hardware components for conducting data or signal processing or for executing computer code stored in memory 1104. The processing circuitry 1102 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 1102 may further include computer executable code that controls operation of the programmable device.

The system bus 1106 may be any of several types of bus structures that may further interconnect to a memory bus (with or without a memory controller), a peripheral bus, and/or a local bus using any of a variety of bus architectures. The memory 1104 may be one or more devices for storing data and/or computer code for completing or facilitating methods described herein. The memory 1104 may include database components, object code components, script components, or other types of information structure for supporting the various activities herein. Any distributed or local memory device may be utilized with the systems and methods of this description. The memory 1104 may be communicably connected to the processing circuitry 1102 (e.g., via a circuit or any other wired, wireless, or network connection) and may include computer code for executing one or more processes described herein. The memory 1104 may include non-volatile memory 1108 (e.g., read-only memory (ROM), erasable programmable read-only memory (EPROM), electrically erasable programmable read-only memory (EEPROM), etc.), and volatile memory 1110 (e.g., random-access memory (RAM)), or any other medium which can be used to carry or store desired program code in the form of machine-executable instructions or data structures and which can be accessed by a computer or other machine with processing circuitry 1102. A basic input/output system (BIOS) 1112 may be stored in the non-volatile memory 1108 and can include the basic routines that help to transfer information between elements within the computer system 1100.

The computer system 1100 may further include or be coupled to a non-transitory computer-readable storage medium such as the storage device 1114, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 1114 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 1114 and/or in the volatile memory 1110, which may include an operating system 1116 and/or one or more program modules 1118. All or a portion of the examples disclosed herein may be implemented as a computer program 1120 stored on a transitory or non-transitory computer-usable or computer-readable storage medium (e.g., single medium or multiple media), such as the storage device 1114, which includes complex programming instructions (e.g., complex computer-readable program code) to cause the processing circuitry 1102 to carry out actions described herein. Thus, the computer-readable program code of the computer program 1120 can comprise software instructions for implementing the functionality of the examples described herein when executed by the processing circuitry 1102. In some examples, the storage device 1114 may be a computer program product (e.g., readable storage medium) storing the computer program 1120 thereon, where at least a portion of a computer program 1120 may be loadable (e.g., into a processor) for implementing the functionality of the examples described herein when executed by the processing circuitry 1102. The processing circuitry 1102 may serve as a controller or control system for the computer system 1100 that is to implement the functionality described herein.

The computer system 1100 may include an input device interface 1122 configured to receive input and selections to be communicated to the computer system 1100 when executing instructions, such as from a keyboard, mouse, touch-sensitive surface, etc. Such input devices may be connected to the processing circuitry 1102 through the input device interface 1122 coupled to the system bus 1106 but can be connected through other interfaces, such as a parallel port, an Institute of Electrical and Electronic Engineers (IEEE) 1394 serial port, a Universal Serial Bus (USB) port, an IR interface, and the like. The computer system 1100 may include an output device interface 1124 configured to forward output, such as to a display, a video display unit (e.g., a liquid crystal display (LCD) or a cathode ray tube (CRT)). The computer system 1100 may include a communications interface 1126 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to an aspect, a computer system, vehicle, method, computer program product and non-transitory computer-readable storage medium according to any of the following examples is provided.

Example 1: A computer system (100) comprising processing circuitry (110) configured to: obtain speed data (305) associated with a ground speed (vₓ) and a rotation speed (ω) of a wheel (8) of the vehicle (1), obtain wheel force data (310) associated with a wheel torque (Tₚ) and a longitudinal tire force (Fₓ) applied to the wheel (8), obtain reference ground surface data (320) comprising a set of reference ground surface types (325), determine a slip power loss (Pₛₗᵢₚ) and a rolling resistance power loss (Pᵣₒₗₗ) for a tire (9) of the wheel (8) based on the speed data (305) and the wheel force data (310), determine a ground surface type (321) for a surface (2) in contact with the tire (9) based on the slip power loss (Pₛₗᵢₚ) and rolling resistance power loss (Pᵣₒₗₗ) and the set of reference ground surface types (325), and provide control data (350) for the vehicle (1) based on the ground surface type (321).

Example 2: The computer system (100) of Example 1, wherein the processing circuitry (110) is further configured to: determine the ground surface type (321) based on both the slip power loss (Pₛₗᵢₚ) and the rolling resistance power loss (Pᵣₒₗₗ) independent from each other.

Example 3: The computer system (100) of Example 1 or 2, wherein each reference ground surface type (325) is associated with surface type indicator data associated with a reference slip power loss (Piₛₗᵢₚ) and a reference rolling resistance power loss (Piᵣₒₗₗ) and the processing circuitry (110) is configured to determine the ground surface type (321) based on said surface type indicator data.

Example 4: The computer system (100) of any of Examples 1-3, wherein the processing circuitry (110) is further configured to: obtain surface inclination data (380) associated with the inclination of the surface (2), and determine a normal force (F_{z}) exerted on the tire (9) based on the wheel force data (310) and the surface inclination data (380).

Example 5: The computer system (100) of Example 4, wherein the processing circuitry (110) is further configured to: estimate a rolling resistance power loss constant (R_{cc1}) based on the rolling resistance power loss (Pᵣₒₗₗ), the speed data (305) and the normal force (F_{z}), and determine the ground surface type (321) based on the rolling resistance power loss constant (R_{cc1}).

Example 6: The computer system (100) of any of Examples 1-5, wherein the processing circuitry (110) is further configured to: estimate a slip power loss constant (R_{cc2}) based on the slip power loss (Pₛₗᵢₚ) and the longitudinal tire force (Fₓ), and determine the ground surface type (321) based on the slip power loss constant (R_{cc2}).

Example 7: The computer system (100) of any of Examples 1-6, wherein the processing circuitry (110) is further configured to: obtain tire reference data (370) associated with characteristics of the tire (9), and determine the slip power loss (Pₛₗᵢₚ) and the rolling resistance power loss (Pᵣₒₗₗ) for the tire (9) based on the tire reference data (370).

Example 8: The computer system (100) of any of Examples 1-7, wherein the processing circuitry (110) is further configured to: determine a change in ground surface type (321) of the surface (2), and responsive to the change in ground surface type (321) provide control data (350) for the vehicle (1).

Example 9: The computer system (100) of any of Examples 1-8, wherein the processing circuitry (110) is further configured to: provide control data (350) for control of at least one of: a slip control system (501), a traction control system (502), a propulsion control system (503) and user interface (504) configured to provide an indication to a user.

Example 10: The computer system (100) of any of Examples 1-9, wherein the processing circuitry (110) is further configured to: determine a data point (D) based on the slip power loss (Pₛₗᵢₚ) and the rolling resistance power loss (Pᵣₒₗₗ), and determine the ground surface type (321) by mapping of the data point (D) to the set of reference ground surface types (325).

Example 11: The computer system (100) of any of Examples 1-10, wherein the processing circuitry (110) is further configured to: determine a probability value (x) for each reference ground surface type (325), the probability value (x) being associated with the probability of the ground surface type (321) for the surface (2) being of the reference ground surface type (325), and determine the ground surface type (321) based on the probability values (x).

Example 12: The computer system (100) of Example 11, further comprising a probability determining model (384) configured to determine the probability values (x), wherein the processing circuitry (110) is further configured to: train the probability determining model (384) based on a classification algorithm such as logistic regression, support vector machine or a neural network.

Example 13: The computer system (100) of Example 12, wherein the processing circuitry (110) is further configured to operate in a training mode, wherein the processing circuitry (110) is configured to: obtain surface definition data (396) associated with a set surface type of the surface (2), assign a ground surface type (321) to the surface (2) based on the surface definition data (396), and train the probability determining model (384) based on operation of the vehicle (1) on the surface (2).

Example 14: The computer system (100) of any of Examples 1 to 13, wherein the processing circuitry (110) is further configured to: obtain speed data (305) associated with a ground speed (vₓ) and a rotation speed (ω) of each of a first and second wheel (8) of the vehicle (1), obtain wheel force data (310) associated with at least a wheel torque (Tₚ) and a longitudinal tire force (Fₓ) applied to each of the first and second wheel (8), determine a slip power loss (Pₛₗᵢₚ) and a rolling resistance power loss (Pᵣₒₗₗ) for a tire (9) of each of the first and second wheel (8), determine a ground surface type (321) for a surface (2) in contact with the tire (9) of each of the first and second wheel (8), and provide control data for the vehicle (1) based on the ground surface type for each of the first and second wheel (8).

Example 15: The computer system (100) of Example 14, wherein the first and second wheel (8) are arranged at opposite longitudinal sides of the vehicle (1).

Example 16: The computer system (100) of Example 14, wherein the first and second wheel (8) are arranged at the same longitudinal side of the vehicle (1).

Example 17: The computer system (100) of any of Examples 1-16, wherein the processing circuitry (110) is further configured to: determine the slip power loss (Pₛₗᵢₚ) based on the rotation speed (ω) of the wheel (8), a radius (r) of the wheel (8), the ground speed (vₓ) of the wheel (8) and the longitudinal tire force (Fₓ).

Example 18: The computer system (100) of any of Examples 1-17, wherein the processing circuitry (110) is further configured to: determine the rolling resistance power loss (Pᵣₒₗₗ) based on the rotation speed (ω) of the wheel (8) and the wheel torque (Tₚ) applied to the wheel (8).

Example 19: The computer system (100) of any of Examples 1-18, wherein the processing circuitry (110) is further configured to: obtain the speed data from one or more speed sensors comprising at least one of a ground speed sensor (281) such as a radar and a wheel speed sensor (282) such as a wheel speed encoder.

Example 20: The computer system (100) of any of Examples 1-19, wherein the wheel force data (310) comprises wheel torque data (311) associated with the wheel torque (Tₚ) and the processing circuitry (110) is further configured to obtain the wheel torque data (311) from a propulsion control system (503) of the vehicle (1).

Example 21: The computer system (100) of any of Examples 1-20, wherein the wheel force data (310) comprises longitudinal tire force data (312) associated with the longitudinal tire force (Fₓ) and the processing circuitry (110) is further configured to obtain the longitudinal tire force data (312) from an accelerometer (283) arranged at the tire (9).

Example 22: The computer system (100) of Example 1, wherein the processing circuitry (110) is further configured to: obtain speed data (305) associated with a ground speed (vₓ) and a rotation speed (ω) of each of a plurality of wheels (8) of the vehicle (1), obtain wheel force data (310) associated with at least a wheel torque (Tₚ) and a longitudinal tire force (Fₓ) applied to each of the plurality of wheels (8), determine a slip power loss (Pₛₗᵢₚ) and a rolling resistance power loss (Pᵣₒₗₗ) for a tire (9) of each of the plurality of wheels (8), determine a ground surface type (321) for a surface (2) in contact with the tire (9) of each of the plurality of wheels (8), and provide control data for the vehicle (1) based on the ground surface type for each of the plurality of wheels (8), wherein the wheel force data (310) comprises wheel torque data (311) associated with the wheel torque (Tₚ) and the processing circuitry (110) is further configured to obtain the wheel torque data (311) from a propulsion control system (503) of the vehicle (1), and wherein the wheel force data (310) comprises longitudinal tire force data (312) associated with the longitudinal tire force (Fₓ) and the processing circuitry (110) is further configured to obtain the longitudinal tire force data (312) from an accelerometer (283) arranged at the tire (9), and wherein the processing circuitry (110) is further configured to: determine the slip power loss (Pₛₗᵢₚ) based on the rotation speed (ω) of the wheel (8), a radius (r) of the wheel (8), the ground speed (vₓ) of the wheel (8) and the longitudinal tire force (Fₓ).

Example 23: A vehicle (1) comprising the computer system (100) of any one of Examples 1 to 22.

Example 24: A computer-implemented method comprising: obtaining, by processing circuitry (110) of a computer system (100), speed data (305) associated with at least one of a ground speed and a rotation speed of a wheel (8) of the vehicle (1), obtaining, by the processing circuitry (110), wheel force data (310) associated with a wheel torque (Tₚ) and a longitudinal tire force (Fₓ) applied to the wheel (8), obtaining, by the processing circuitry (110), reference ground surface data (320) comprising a set of reference ground surface types (325), determining, by the processing circuitry (110), a slip power loss (Pₛₗᵢₚ) and a rolling resistance power loss (Pᵣₒₗₗ) for a tire (9) of the wheel (8) based on the speed data (305) and the wheel force data (310), determining, by the processing circuitry (110), a ground surface type (321) for a surface (2) in contact with the tire (9) based on the slip power loss (Pₛₗᵢₚ) and rolling resistance power loss (Pᵣₒₗₗ) and the set of reference ground surface types (325), providing, by the processing circuitry, control data (350) for the vehicle (1) based on the ground surface type (321).

Example 25: The computer-implemented method of Example 24, further comprising: determining, by the processing circuitry (110), the ground surface type (321) based on both the slip power loss (Pₛₗᵢₚ) and the rolling resistance power loss (Pᵣₒₗₗ) independent from each other.

Example 26: The computer-implemented method of Example 24 or 25, wherein each reference ground surface type (325) is associated with surface type indicator data associated with a reference slip power loss (Piₛₗᵢₚ) and a reference rolling resistance power loss (Piᵣₒₗₗ), wherein the method further comprises: determining, by the processing circuitry (110), the ground surface type (321) based on said surface type indicator data.

Example 27: The computer-implemented method of any of Examples 24-26, further comprising: obtaining, by the processing circuitry (110), surface inclination data (380) associated with the inclination of the surface (2), and determining, by the processing circuitry (110), a normal force (F_{z}) exerted on the tire (9) based on the wheel force data (310) and the surface inclination data (380).

Example 28: The computer-implemented method of Example 27, further comprising: estimating, by the processing circuitry (110), a rolling resistance power loss constant (R_{cc1}) based on the rolling resistance power loss (Pᵣₒₗₗ), the speed data (305) and the normal force (F_{z}), and determining, by the processing circuitry (110), the ground surface type (321) based on the rolling resistance power loss constant (R_{cc1}).

Example 29: The computer-implemented method of any of Examples 24-28, further comprising: estimating, by the processing circuitry, a slip power loss constant (R_{cc2}) based on the slip power loss (Pₛₗᵢₚ) and the longitudinal tire force (Fₓ), and determining, by the processing circuitry (110), a ground surface type (321) based on the slip power loss constant (R_{cc2}).

Example 30: The computer-implemented method of any of Examples 24-29, further comprising: obtaining, by the processing circuitry (110), tire reference data (370) associated with characteristics of the tire (9), and determining, by the processing circuitry (110), the slip power loss (Pₛₗᵢₚ) and the rolling resistance power loss (Pᵣₒₗₗ) for the tire (9) based on the tire reference data (370).

Example 31: The computer-implemented method of any of Examples 24-30, further comprising: determining, by the processing circuitry (110), a change in ground surface type (321) of the surface (2), and responsive to the change in ground surface type (321) providing, by the processing circuitry (110), control data (350) for the vehicle (1).

Example 32: The computer-implemented method of any of Examples 24-31, further comprising: providing, by the processing circuitry (110), control data for control of at least one of: a slip control system (501), a traction control system (502), a propulsion control system (503) and user interface (504) configured to provide an indication to a user.

Example 33: The computer-implemented method of any of Examples 24-32, further comprising: determining, by the processing circuitry (110), a data point (D) based on the slip power loss (Pₛₗᵢₚ) and the rolling resistance power loss (Pᵣₒₗₗ), and determining, by the processing circuitry (110), the ground surface type (321) by mapping of the data point (D) to the set of reference ground surface types (325).

Example 34: The computer-implemented method of any of Examples 24-33, further comprising: determining, by the processing circuitry (110), a probability value (x) for each reference ground surface type (325), the probability value (x) being associated with the probability of the ground surface type (321) for the surface (2) being of the reference ground surface type (325), and determining, by the processing circuitry (110), the ground surface type (321) based on the probability values (x).

Example 35: The computer-implemented method of Example 34, wherein the computer system (100) further comprises a probability determining model (384) configured to determine the probability values (x), the method further comprising: training, by the processing circuitry (110), the probability determining model (384) based on a classification algorithm such as logistic regression, support vector machine or a neural network.

Example 36: The computer-implemented method of Example 35, further comprising: operating, by the processing circuitry (110) in a training mode, and in said training mode: obtaining, by the processing circuitry (110), surface definition data (396) associated with a set surface type of the surface (2), assigning, by the processing circuitry (110), a ground surface type (321) to the surface (2) based on the surface definition data (396), and training, by the processing circuitry (110), the probability determining model (384) based on operation of the vehicle (1) on the surface (2).

Example 37: The computer-implemented method of any of Examples 24-36, further comprising: obtaining, by the processing circuitry (110), speed data (305) associated with a ground speed (vₓ) and a rotation speed (ω) of each of a first and second wheel (8) of the vehicle (1), obtaining, by the processing circuitry (110), wheel force data (310) associated with at least a wheel torque (Tₚ) and a longitudinal tire force (Fₓ) applied to each of the first and second wheel (8), determining, by the processing circuitry (110), a slip power loss (Pₛₗᵢₚ) and a rolling resistance power loss (Pᵣₒₗₗ) for a tire (9) of the first and second wheel (8), determining, by the processing circuitry (110), a ground surface type (321) for a surface (2) in contact with the tire (9) of each of the first and second wheel (8), and providing, by the processing circuitry (110), control data for the vehicle (1) based on the ground surface type for each of the first and second wheel (8).

Example 38: The computer-implemented method of Example 37, wherein the first and second wheel (8) are arranged at opposite longitudinal sides of the vehicle (1).

Example 39: The computer-implemented method of Example 37, wherein the first and second wheel (8) are arranged at the same longitudinal side of the vehicle (1).

Example 40: The computer-implemented method of any of Examples 24-39, further comprising: determining, by the processing circuitry (110), the slip power loss (Pₛₗᵢₚ) based on the rotation speed (ω) of the wheel (8), a radius (r) of the wheel (8), the ground speed (vₓ) of the wheel (8) and the longitudinal tire force (Fₓ).

Example 41: The computer-implemented method of any of Examples 24-40, further comprising: determining, by the processing circuitry (110), the rolling resistance power loss (Pᵣₒₗₗ) based on the rotation speed (ω) of the wheel (8) and the wheel torque (Tₚ) applied to the wheel (8).

Example 42: The computer-implemented method of any of Examples 24-41, further comprising: obtaining, by the processing circuitry (110), the speed data from one or more speed sensors comprising at least one of a ground speed sensor (281) such as a radar and a wheel speed sensor (282) such as a wheel speed encoder.

Example 43: The computer-implemented method of any of Examples 24-42, wherein the wheel force data (310) comprises wheel torque data (311) associated with the wheel torque (Tₚ) and the method further comprises: obtaining, by the processing circuitry (110), the wheel torque data (311) from a propulsion control system (503) of the vehicle (1).

Example 44: The computer-implemented method of any of Examples 24-43, wherein the wheel force data (310) comprises longitudinal tire force data (312) associated with the longitudinal tire force (Fₓ) and the method further comprises: obtaining, by the processing circuitry (110), the longitudinal tire force data (312) from an accelerometer (283) arranged at the tire (9).

Example 45: A computer program product comprising program code for performing, when executed by the processing circuitry, the method of any of Examples 24-44.

Example 46: A non-transitory computer-readable storage medium comprising instructions, which when executed by the processing circuitry, cause the processing circuitry to perform the method of any of Examples 24-44.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
obtain speed data associated with a ground speed and a rotation speed of a wheel of the vehicle;
obtain wheel force data associated with a wheel torque and a longitudinal tire force applied to the wheel;
obtain reference ground surface data comprising a set of reference ground surface types;
determine a slip power loss and a rolling resistance power loss for a tire of the wheel based on the speed data and the wheel force data;
determine a ground surface type for a surface in contact with the tire based on the slip power loss and rolling resistance power loss and the set of reference ground surface types; and
provide control data for the vehicle based on the ground surface type.

2. The computer system of claim 1, wherein the processing circuitry is further configured to:
determine the ground surface type based on both the slip power loss and the rolling resistance power loss independent from each other.

3. The computer system of claim 1, wherein each reference ground surface type is associated with surface type indicator data associated with a reference slip power loss and a reference rolling resistance power loss and the processing circuitry is configured to determine the ground surface type based on the surface type indicator data.

4. The computer system of claim 1, wherein the processing circuitry is further configured to:
obtain surface inclination data associated with the inclination of the surface; and
determine a normal force exerted on the tire based on the wheel force data and the surface inclination data.

5. The computer system of claim 4, wherein the processing circuitry is further configured to:
estimate a rolling resistance power loss constant based on the rolling resistance power loss, the speed data and the normal force; and
determine the ground surface type based on the rolling resistance power loss constant.

6. The computer system of claim 1, wherein the processing circuitry is further configured to:
estimate a slip power loss constant based on the slip power loss and the longitudinal tire force; and
determine the ground surface type based on the slip power loss constant.

7. The computer system of claim 1, wherein the processing circuitry is further configured to:
obtain tire reference data associated with characteristics of the tire; and
determine the slip power loss and the rolling resistance power loss for the tire based on the tire reference data.

8. The computer system of claim 1, wherein the processing circuitry is further configured to:
determine a change in ground surface type of the surface; and
responsive to the change in ground surface type, provide control data for the vehicle.

9. The computer system of claim 1, wherein the processing circuitry is further configured to:
provide control data for control of at least one of: a slip control system, a traction control system, a propulsion control system, and user interface configured to provide an indication to a user.

10. The computer system of claim 1, wherein the processing circuitry is further configured to:
determine a data point based on the slip power loss and the rolling resistance power loss; and
determine the ground surface type by mapping of the data point to the set of reference ground surface types.

11. The computer system of claim 1, wherein the processing circuitry is further configured to:
determine a probability value for each reference ground surface type, the probability value being associated with the probability of the ground surface type for the surface being of the reference ground surface type; and
determine the ground surface type based on the probability values.

12. The computer system of claim 11, further comprising a probability determining model configured to determine the probability values, wherein the processing circuitry is further configured to:
train the probability determining model based on a classification algorithm such as logistic regression, support vector machine or a neural network.

13. The computer system of claim 1, wherein the processing circuitry is further configured to:
obtain speed data associated with a ground speed and a rotation speed of each of a first and second wheel of the vehicle;
obtain wheel force data associated with at least a wheel torque and a longitudinal tire force applied to each of the first and second wheel;
determine a slip power loss and a rolling resistance power loss for a tire of each of the first and second wheel;
determine a ground surface type for a surface in contact with the tire of each of the first and second wheel; and
provide control data for the vehicle based on the ground surface type for each of the first and second wheel.

14. The computer system of claim 1, wherein the processing circuitry is further configured to:
determine the slip power loss based on the rotation speed of the wheel, a radius of the wheel, the ground speed of the wheel, and the longitudinal tire force.

15. The computer system of claim 1, wherein the processing circuitry is further configured to:
determine the rolling resistance power loss based on the rotation speed of the wheel and the wheel torque applied to the wheel.

16. The computer system of claim 1, wherein the processing circuitry is further configured to:
obtain speed data associated with a ground speed and a rotation speed of each of a plurality of wheels of the vehicle;
obtain wheel force data associated with at least a wheel torque and a longitudinal tire force applied to each of the plurality of wheels;
determine a slip power loss and a rolling resistance power loss for a tire of each of the plurality of wheels;
determine a ground surface type for a surface in contact with the tire of each of the plurality of wheels; and
provide control data for the vehicle based on the ground surface type for each of the plurality of wheels;
wherein the wheel force data comprises wheel torque data associated with the wheel torque and the processing circuitry is further configured to obtain the wheel torque data from a propulsion control system of the vehicle;
wherein the wheel force data comprises longitudinal tire force data associated with the longitudinal tire force and the processing circuitry is further configured to obtain the longitudinal tire force data from an accelerometer arranged at the tire; and
wherein the processing circuitry is further configured to:
determine the slip power loss based on the rotation speed of the wheel, a radius of the wheel, the ground speed of the wheel, and the longitudinal tire force.

17. A vehicle comprising the computer system of claim 1.

18. A computer-implemented method comprising:
obtaining, by processing circuitry of a computer system, speed data associated with at least one of a ground speed and a rotation speed of a wheel of the vehicle;
obtaining, by the processing circuitry, wheel force data associated with a wheel torque and a longitudinal tire force applied to the wheel;
obtaining, by the processing circuitry, reference ground surface data comprising a set of reference ground surface types;
determining, by the processing circuitry, a slip power loss and a rolling resistance power loss for a tire of the wheel based on the speed data and the wheel force data;
determining, by the processing circuitry, a ground surface type for a surface in contact with the tire based on the slip power loss and rolling resistance power loss and the set of reference ground surface types; and
providing, by the processing circuitry, control data for the vehicle based on the ground surface type.

19. A computer program product comprising program code for performing, when executed by the processing circuitry, the method of claim 18.

20. A non-transitory computer-readable storage medium comprising instructions, which when executed by the processing circuitry, cause the processing circuitry to perform the method of claim 18.
